(19) United States
(12) Patent Application Publication
(10) Pub. No.: US 2026/0146181 A1
(43) Pub. Date: May 28, 2026

(54) Premixed Ready-To-Use (RTU) Adhesive

(71) Applicant: Laticrete International, Inc., Bethany, CT (US)

(72) Inventors: Heath Salvati, Harwinton, CT (US); Yunbo Chen, Woodbridge, CT (US); Rakibul Khan, Hamden, CT (US); Haihong Hailey Jiang, Plano, TX (US); Rajeswari Kompalli, Bethany, CT (US)

(21) Appl. No.: 19/402,164

(22) Filed: Nov. 26, 2025

Related U.S. Application Data
(60) Provisional application No. 63/725,168, filed on Nov. 26, 2024.

(51) Int. Cl. C09J 1/00; C09J 11/04; C09J 11/06; C09J 11/08; C09J 113/02

(52) U.S. Cl. CPC C09J 1/00; C09J 11/04; C09J 11/06; C09J 11/08; C09J 113/02

(57) ABSTRACT

Ready-to-use tile/stone adhesive formulations that at least include an acrylic-styrene low-medium Tg latex binder, an acrylic-styrene high temperature resistant latex binder, an acrylic-styrene high Tg latex binder and a liquid hydraulic cement binder The present RTU adhesives may further include one or more of the following: a tackifier, in-can stabilizer present, anti-microbial, adhesion promoter, sand, pigment, one or more fiber materials, one or more thickeners, one or more filler materials, and/or a crosslinker. The invention is further directed to methods of bonding tile to a substrate using the various RTU adhesives of the invention in combination with an alkaline activator solution, as well as bonding systems that include the present RTU adhesives of the invention in combination with an alkaline activator solution.

The present invention claims priority to U.S. Provisional Patent Application No. 63/725,168 filed Nov. 26, 2024, the entirety of which is incorporated herein by reference.

### TECHNICAL FIELD

The present invention is directed to a ready-to-use tile and stone adhesive that meets ANSI A118.15 American National Standard Specifications for Improved Modified Dry-Set Cement Mortar, the highest ANSI standard for a cement based ceramic tile adhesive.

### DESCRIPTION OF RELATED ART

There are different types of tile adhesives in today's market for a wide variety of applications. A common use of tile adhesives is in the construction industry, and in particular, for use in bonding tile, stone, masonry and other types of building materials onto a substrate surface.

In the field, the substrate, tile and usage of the structure can vary from project to project, hence different forms of tile adhesives exist. For instance, well known currently available tile adhesives include polymer modified cement-based adhesives, two-part or three-part polymer adhesives (e.g., epoxy-based adhesives), as well as one-part polymer ready-to-use (RTU) adhesives. Each of these types of tile adhesives has its advantages and disadvantages.

In analyzing these tile adhesives, performance of each is determined by several International Standards (ISO/EN Standards) & domestic standards (ANSI). Polymer modified cement-based adhesives are most widely used among all tile adhesives since they are readily available, relatively cost effective and can function in most projects. Epoxy-based adhesives (2- or 3-part systems) have superior performance as compared to cement or RTU adhesives. However, a disadvantage is that epoxy-based adhesives require mixing prior to use thereof, and are only used in special projects due to their high cost and toxicity. Other popular adhesives are polymer modified cement-based adhesives. These cement-based adhesives are readily available, cost effective and can function in most projects, making them the most widely used materials among all tile adhesives. However, both cement-based and epoxy-based adhesives need mixing prior to use thereof. In particular. cement-based adhesives need to be mixed with the right amount of water to produce a creamy paste, while different parts of epoxy-based adhesives need to be mixed together into one spreadable mixture before use.

As an alternative to tile adhesives that require mixing, currently available adhesives also include premixed and/or one-part adhesive compositions that do not require mixing. Since these adhesives come ready-to-use (RTU) in a pre-mixed state, these types of adhesives are often easier to use than cementitious adhesives and/or two- or three-part adhesive systems. One of the biggest advantages of such premixed RTU adhesives is that they do not need to be mixed with other constituent(s) prior to use thereof, which aids in their ease of use. Another advantage of RTU adhesives is that they are relatively safe as they do not generate dust.

Today, RTU adhesives are the most preferred technology for modern consumers in the construction markets. However, limitations to the current commercially available RTU tile adhesives are that they lack the same kind of durability and performance as compared to cement-based adhesives. They also do not have sufficient water resistance and physical strength as compared to that of the cement-based adhesives, which limits their use and applications.

Furthermore, current commercially available RTU adhesives are limited in their scope of application due to their curing demands and mechanisms. Due to the requirement that water be capable of escaping the adhesive during the curing process, known water-based RTU adhesives have difficulty curing when used between two non-porous surfaces, when the humidity is particularly high, and/or when temperatures are particularly low. Particularly troublesome is when the need arises to use a water-based RTU adhesive between two non-porous surfaces, with large format tiles in a high humidity environment, such as, when using a large format porcelain tile over a liquid applied waterproofing membrane.

In view of the foregoing, there continues to be a need for new and improved water-based RTU adhesives having superior chemical and physical properties (e.g., durability, water resistance, etc.), and are able to effectively cure between two non-porous surfaces, when humidity is high, and/or when temperatures are low, for which the present invention provides a solution thereto.

### SUMMARY OF THE INVENTION

Bearing in mind the problems and deficiencies of the prior art, it is therefore an object of the present invention to provide ready-to-use adhesive formulations, particularly tile/stone adhesive formulations, that meets performance requirements of a modified dry-set cement mortar.

Another object of the present invention is to provide tile adhesive formulations that have enhanced durability, water resistance, and strength, as compared to currently known adhesives.

Still another object of the present invention is to provide tile adhesive formulations that effectively cure in environments having high relative humidity, low temperatures, and/or between two non-porous materials or substrates.

The above and other objects, which will be apparent to those skilled in the art, are achieved in the present invention which is directed to tile adhesives in a ready-to-use formulation that includes a first binder material comprising a low-medium Tg latex binder, a second binder material comprising a water resistant latex binder, a third binder material comprising a high Tg latex binder, and a fourth binder material comprising a liquid hydraulic cement binder. The fourth binder material may comprise an aqueous calcium aluminate cement suspension.

In one or more embodiments the first binder material is present in an amount ranging from greater than 0 wt. % to 35 wt. %; the second binder material is present in an amount ranging from greater than 0 wt. % to 20 wt. %; the third binder material is present in an amount ranging from greater than 0 wt. % to 10 wt. %; and the fourth binder material is present in an amount ranging from greater than 0 wt. % to 20 wt. %. All weight % is based on total weight of the adhesive formulation.

The formulations may also include a tackifier, an in-can stabilizer, an anti-microbial, an adhesion promoter, sand, pigment, one or more thickeners, and one or more filler materials. The foregoing adhesive formulations of the invention are one-part formulations requiring no mixing prior to use thereof. In these embodiments, the tackifier may comprise an acrylated compound present in an amount ranging from greater than 0 wt. % to 3 wt. %; the in-can stabilizer may be present in an amount ranging from 0.01 wt. % to 0.1 wt. %; the anti-microbial may be present in an amount ranging from 0.01 wt. % to 0.1 wt. %; the adhesion promoter may be present in an amount ranging from 0.1 wt. % to 1 wt. %; and the sand may be present in an amount ranging from 65 wt. % to 75 wt. %. The one or more thickeners may comprise a first thickener comprising a clay thickener present in an amount ranging from 0.3 wt. % to 1 wt. %; a second thickener comprising a cellulose thickener present in an amount ranging from 0.05 wt. % to 0.5 wt. %; and a third thickener comprising a silica fume thickener present in an amount ranging from 0.05 wt. % to 0.5 wt. %.

Embodiments of the invention are also directed to methods of bonding tile to a substrate. The methods include providing a ready-to-use (RTU) tile adhesive, applying the RTU tile adhesive to a substrate, providing an alkaline activator solution, and then depositing the alkaline activator solution to an exposed surface of the RTU tile adhesive. The alkaline activator solution induces a hydraulic reaction between the liquid hydraulic cement binder and the alkaline activator solution. Tile is then laid over the hydraulically induced RTU tile adhesive to attach the tile to the RTU tile adhesive, followed by curing the hydraulically induced RTU tile adhesive to bond the tile to the RTU tile adhesive. The RTU tile adhesive comprises: a first binder material comprising an acrylic-styrene low-medium Tg latex binder; a second binder material comprising an acrylic-styrene high temperature resistant latex binder; a third binder material comprising an acrylic-styrene high Tg latex binder; a fourth binder material comprising a liquid hydraulic cement binder; and one or more additional ingredients, wherein the adhesive formulation is a one-part formulation requiring no mixing prior to use.

In one or more embodiments, the liquid hydraulic cement binder may be an aqueous calcium aluminate cement suspension. The alkaline activator solution may be one or more alkaline compositions in an aqueous diluent. For instance, the one or more alkaline compositions may be selected from the group consisting of lithium hydroxide, lithium silicate, LiSO₄, NaOH, KOH, sodium carbonate, and combinations thereof. In certain embodiments, the aqueous diluent may be water and the alkaline activator solution may be one or more alkaline compositions present in an amount ranging from 0.1 wt. % to 40 wt. %, with the water present in an amount ranging from 99.9 wt. % to 60 wt. %, based on a total weight of the alkaline activator solution.

In the methods of bonding tile to a substrate the RTU tile adhesive may be a first binder material present in an amount ranging from 12 wt. % to 20 wt. %; a second binder material present in an amount ranging from 2 wt. % to 8 wt. %; a third binder material present in an amount ranging from 1 wt. % to 3 wt. %; and a fourth binder material comprising an aqueous calcium aluminate cement present in an amount ranging from 3 wt. % to 12 wt. %, wherein weight % is based on total weight of the adhesive formulation.

It should be appreciated and understood that all above weight percentages are based on a total weight of the adhesive formulation.

Still other objects and advantages of the invention will in part be obvious and will in part be apparent from the specification.

### MODE(S) FOR CARRYING OUT INVENTION

The embodiments of the present invention can comprise, consist of, and consist essentially of the features and/or steps described herein, as well as any of the additional or optional ingredients, components, steps, or limitations described herein or would otherwise be appreciated by one of skills in the art. It is to be understood that all concentrations disclosed herein are by weight percent (wt. %.) based on a total weight of the composition unless otherwise indicated.

The present invention refers to unique tile and stone ready-to-use adhesives or mortars that meet performance requirements of a modified dry-set cement mortar (hereinafter referred to as adhesive(s)). The term “ready-to-use” (“RTU”) refers to an adhesive or mortar formulation that is a one-part formulation that requires no mixing prior to use thereof, which may be referred to herein as a “RTU” adhesive. As used herein, for ease of understanding, the terms tile, stone, masonry and other types of building materials shall be referred to collectively and generally as “tile”.

In accordance with the various embodiments, the present invention is directed to ready-to-use “tile” adhesives, and their methods and use thereof, that have properties and perform like that of a cement-based adhesive. It has been found that the present adhesives meet ANSI A118.4 (the American National Standard Specifications for Modified Dry-Set Cement Mortar (modified mortar)), and ANSI A118.15 standards (the American National Standard Specifications for Improved Modified Dry-Set Cement Mortar (improved modified mortar)). Both ANSI A118.4 and ANSI A118.15 standards are the highest standards for cement based ceramic tile adhesives.

In referring to the adhesives of the invention being premixed and ready-to-use, it should be understood that no additional water needs to be added to the compositions of the invention prior to use thereof. The water-based RTU adhesives of the invention are suited for use with tile and in tiling applications. The present various water-based RTU adhesives provide superior water resistance and physical strength, as compared to currently available RTU adhesives. They are also able to effectively cure in conditions where the present water-based RTU adhesive(s) is used and/or applied between two non-porous surfaces, with large format tiles, in high humidity environments, and/or environments/settings having low temperatures.

They can be used in interior and exterior applications, and may be exposed to water and/or used in submerged application installations. The testing for physical performance have been confirmed and validated by ANSI A118.4 and ANSI A118.15.

In accordance with invention, the instant premixed water-based RTU adhesives include a combination of binder materials. In one or more embodiments, the present RTU adhesives include a first binder material comprising a low to medium glass transition temperature (Tg) latex binder. Suitable latex binders for use in the invention include acrylic-styrene low-medium (Tg) latex polymer dispersion binders. For instance, a suitable acrylic-styrene low-medium (Tg) latex binder may be a modified acrylic-styrene (SA) latex polymer material having excellent water resistance and barrier properties, such as, those having a higher amount of soft monomer (e.g., butyl acrylate) as compared to known styrene butadiene (SB) polymers. In one or more embodiments, suitable acrylic-styrene polymer dispersions for use in the invention have properties including, but not limited to, a solids content ranging from about 45% to 60% solids with the remainder being water, a specific gravity ranging from about 0.95 g/cm³ to 1.10 g/cm³, a pH ranging from about 6-9, a viscosity <1000 cps, and a glass transition temperature (Tg) ranging from about −40° C. to 100° C.

In one or more preferred embodiments, the first binder material may comprise a modified acrylic-styrene latex present in the water-based RTU adhesive of the invention in an amount ranging from greater than 0 wt. % to about 35 wt. % (based on a total weight of the RTU adhesive formulation). More preferably the first binder comprising an acrylic-styrene low-medium (Tg) latex binder may be present in the RTU adhesive formulation in amounts ranging from about 12 wt. % to 20 wt. %, and most preferably from about 12.5 wt. % to 18.2 wt. %, based on a total weight of the RTU adhesive formulation. The first acrylic-styrene latex polymer dispersion binder provides the instant resultant RTU adhesives with improved adhesive strength, toughness, flexibility, water impermeability, stability (e.g., compounding stability, in-can stability, etc.), chemical resistance (e.g., chemical, acid, organic solvents, water, stain, abrasion and oil resistance), durability, control of setting speed, and the like.

The second binder material of the present RTU adhesive formulations may be a high glass transition temperature (Tg) latex binder material comprising an acrylate copolymer dispersion. In one or more embodiments the high (Tg) latex binder may be a modified styrene acrylate latex or a styrene acrylic emulsion. For instance, suitable acrylate copolymer dispersions include, but are not limited to, copolymers of styrene and acrylic, such as, a styrene-acrylate copolymer dispersion. In one or more preferred embodiments, the second binder material comprises a styrene-acrylate copolymer dispersion. The styrene-acrylate copolymer dispersion may be present in the RTU adhesive formulations of the invention in an amount ranging from greater than 0 wt. % to 10 wt. %, preferably from about 1 wt. % to 3 wt. %, and most preferably from about 1.2 wt. % to 2.8 wt. %, all based on a total weight of the RTU adhesive formulation. In the one or more preferred embodiments the preferred styrene-acrylate copolymer dispersion may have a solids content ranging from about 45% to 60% solids with the remainder being water (preferably about 45.0%), a density measured at 20° C. of about 1.04 g/cm³, a pH of about 6.0, a viscosity <200 cps, and a Tg of about 97° C. The second binder comprising the modified styrene-acrylate latex binder provides the resultant RTU adhesives of the invention with improved adhesive strength, hardness, compressive strength, shear bonding strength, and chemical resistance.

In one or more preferred embodiments, the RTU adhesives include a third binder material. The third binder material is a high temperature resistant latex binder, preferably an acrylic-styrene copolymer emulsion. The third binder is environmentally friendly as it preferably is a liquid suspension of polymer particles that does not contain alkylphenol ethoxylate (APEO) surfactants. In one or more embodiments, the acrylic-styrene high temperature resistant latex binder may have a solids content of 50% (%+/−1), a pH of 7.0-8.0, a viscosity of 1000 (mPa·s, max) and a Tg (glass transition temperature) of about 24° C. Suitable third binders comprising acrylic-styrene high temperature resistant latex binders also have excellent workability, adhesion after heat aging, and adhesion after water immersion. The high temperature resistant latex binder may be present in the RTU adhesive formulation in amounts ranging from greater than 0 wt. % to 20 wt. %, preferably from about 2 wt. % to 8 wt. %, and most preferably from about 3 wt. % to 6 wt. %, based on a total weight of the RTU adhesive formulation. The third binder comprising an acrylic-styrene copolymer emulsion binder provides the RTU adhesives of the invention with improved adhesion in working environments exposed to water, moisture, humidity, and the like (i.e., wet environments). With this improved adhesion the third binder both enhances and improves the curing process and rate of the instant RTU adhesives when exposed to wet environments, as well as provides the resultant adhesive with excellent adhesion after water immersion and heat aging (both during and after cure).

In one or more preferred embodiments, the present RTU adhesives also include a fourth binder material. The fourth binder is a hydraulic binder, preferably a liquid hydraulic cement binder. The liquid hydraulic cement binder may comprise an aqueous alumina (calcium aluminate) cement suspension induced into a hydraulic reaction using an alkaline solution as an activator, as discussed in more detail below in relation to methods of the invention for application of the present RTU adhesive formulations. That is, the liquid hydraulic cement binder within the present RTU adhesives gets hydraulically induced by an alkaline stimulus upon use of the present RTU adhesives.

In a preferred embodiment, the fourth binder is a liquid calcium aluminate binder that acts as the hydraulic reaction inducer in the present RTU adhesive formulations for use on difficult to cure or adhere to substrate surfaces. More particularly, the fourth binder is preferably an inorganic waterborne calcium aluminate suspension (i.e., a liquefied alumina cement slurry (e.g., alumina cement floated in water)) that is quick and self-drying, and enhances the film formation of the polymer binders in the present RTU adhesive formulations when used in cold and/or humid conditions. Difficult curing substrate surfaces are often characterized by low surface energy, chemical inertness, or specific surface contaminants that prevent adhesives or coatings from properly wetting out (spreading evenly) and forming strong molecular bonds. While not meant to be limiting, difficult to cure or adhere to substrate surfaces may include, but are not limited to, porcelain surfaces, non-absorbent membranes, large format tiles, existing tiles or other non-porous surfaces/substrates, “green” or damp concrete, surfaces/substrates with residues or contaminants, gypsum underlayments, low surface energy plastic membranes (e.g., polytetrafluoroethylene, polyethylene (PE) and polypropylene (PP), silicone rubber, etc.), painted surfaces containing silicones or waxes, metals, and the like. In the various embodiments of the invention, the liquid hydraulic cement binder may be present in the adhesive formulations in amounts ranging from greater than 0 wt. % to 20 wt. %, preferably from about 3 wt. % to 12 wt. %, and most preferably from about 4 wt. % to 8 wt. %, based on a total weight of the RTU adhesive formulation. It should be appreciated that while the present disclosure refers to at least four binder materials, the present water-based RTU adhesives may include any number of binders, as long as one or more of such binders is a liquid hydraulic cement binder.

In one or more embodiments, the present RTU adhesives may further include a tackifier. The tackifier may be an acrylated compound tackifier. In one or more embodiments the tackifier may be a solvent-free, soft waterborne emulsion of rosin ester resin for tackifying latex polymers, such as acrylic latexes, for low temperature and freezer type applications. It is preferably stable when mixed with latexes having a pH greater than 7.0. Properties of such a tackifier may include, but are not limited to, a total solids content of about 56.0±1.0, a viscosity (at 23° C.) of about 1200±400 cps, a pH of 8.5 to 10.5, an average particle size <0.5 micron, and a softening point of about 40° C. In the various RTU adhesives of the invention, the tackifier may be present in the formulation in amounts ranging from 0 wt. % to 6 wt. %, from greater than 0 wt. % to 6 wt. %, preferably from about 1 wt. % to 3 wt. %, and more preferably from about 1.8 wt. % to 2.2 wt. %, based on a total weight of the RTU formulation. The preferred tackifier of the invention is a soft tackifier that softens the present RTU adhesives and increases both tack and peel strength.

In one or more embodiments, the present RTU adhesives may further include an in-can stabilizer. Suitable in-can stabilizers may be those acting as microbiocides that control bacteria, fungi, and algae growth. For instance, the in-can stabilizer may include 2-Methyl-4-isothiazolin-3-one as a main ingredient. The in-can stabilizer may be present in the inventive formulations in amounts ranging from 0 wt. % to 2 wt. %, from greater than 0 wt. % to 2 wt. %, preferably from about 0.01 wt. % to 0.1 wt. %, and more preferably from about 0.02 wt. % to 0.05 wt. %, based on a total weight of the RTU formulation.

The present RTU adhesives of the invention may further include an antimicrobial agent. The antimicrobial agent preferably includes an active ingredient that resists the growth of microbes such as bacteria, mold and mildew. In certain embodiments, the antimicrobial agent may be a quaternary ammonium compound such as, for instance, a formulation containing ortho-phenylphenol (0.21%), a quaternary ammonium complex (di-isobutylphenoxy-ethoxy-ethyldimethylbenzyl-ammonium chloride, 0.69%), and bromine (0.04%). While not meant to be limiting, in one or more embodiments the antimicrobial agent may be a flowable Microban product. The antimicrobial agent may be present in the formulation in amounts ranging from 0 wt. % to 2 wt. %, from greater than 0 wt. % to 2 wt. %, preferably from about 0.01 wt. % to 0.1 wt. %, and more preferably from about 0.01 wt. % to 0.04 wt. %. It should be appreciated that all the wt. % measures disclosed herein are based on a total weight of the RTU formulation.

In accordance with the invention, the present RTU adhesives may further include an adhesion promoter. The adhesion promoter may be an epoxy functional silane oligomer having a polyfunctional structure with gamma-glycidoxy groups. In these adhesion promoters, the gamma-gylcidoxy propyl epoxide ring reacts with many organic groups while its alkoxy silane groups promote adhesion to most inorganic substrates. Suitable adhesion promoters of the invention may have limited volatile organics (e.g., reduce methanol emissions as compared to monomeric epoxy silanes), improved wet and dry adhesion, improved corrosion resistance, as well as be compatible with and used in small amounts in water-based, solvent-borne or high-solids systems. In one or more embodiments, the adhesion promoter may be present in the formulation in amounts ranging from 0 wt. % to 4 wt. %, from greater than 0 wt. % to 4 wt. %, preferably from about 0.1 wt. % to 1.0 wt. %, and more preferably from about 0.2 wt. % to 0.8 wt. %, based on a total weight of the RTU formulation.

As a main constituent, the present RTU adhesives also include sand as a first filler, preferably medium grade or bulk sand. For instance, in one or more embodiments the sand may be a medium grade sand having dimensions of about 0.1 mm to about 0.3 mm, or medium bulk 5010/5030. The sand may be present in the formulation in amounts ranging from about 40 wt. % to 85 wt. %, preferably from about 65 wt. % to 76 wt. %, and more preferably from about 51 wt. % to 76 wt. %, based on a total weight of the RTU formulation.

The RTU adhesives of the invention may also include one or more other filler materials. For instance, the present RTU formulations may include a fine filler, such as a ground calcium carbonate. The fine fillers may be a fine particle size, wet ground white calcitic material having a dry free-flowing powder form. In one or more embodiments, the fine fillers may have properties including, but not limited to, a high whiteness, closely controlled particle size, ease of dispersion, and the like. The fine fillers may be in the present formulations in amounts ranging from 0 wt. % to 6 wt. %, from greater than 0 wt. % to 6 wt. %, preferably from about 0.3 wt. % to 1.0 wt. %, and more preferably from about 0.40 wt. % to 0.80 wt. %, based on a total weight of the RTU formulation.

In one or more embodiments the present RTU adhesives may include a lightweight filler, such as, a perlite-based filler. The lightweight filler is preferably a low density, hydrophobic, closed-cell expanded perlite-based material that replaces at least a portion of heavier fillers, such as silica sand. Use of lightweight fillers in the present formulations provides RTU adhesives having reduced weight per volume unit of product, as compared to adhesives composed only of heavy filler materials. The addition of a lightweight, hydrophobic expanded filler also improves workability and sag resistance of the resultant RTU adhesive. The lightweight filler may be in the present formulations in amounts ranging from 0 wt. % to 4 wt. %, from greater than 0 wt. % to 4 wt. %, preferably from about 0.05 wt. % to 1 wt. %, and more preferably from about 0.10 wt. % to 0.60 wt. %, based on a total weight of the RTU formulation.

The present RTU adhesives may include one or more types of fiber materials. In one or more embodiments, the formulations include a first and second fiber material. The first fiber materials/particles may be plant-based functional fillers, and in particular, a powdered cellulose filler. The fiber particles may have good binding properties, exhibit low moisture absorption and are stable. The first fiber material may act as a reinforcement fiber within the present RTU adhesives. In the present FTU formulas, the fiber particles may be present in amounts ranging from 0 wt. % to 6 wt. %, from greater than 0 wt. % to 6 wt. %, from about 0.5 wt. % to 1.5 wt. %, and preferably from about 0.9 wt. % to 1.1 wt. %, based on a total weight of the RTU formulation.

The fiber materials/particles may also include flocking fibers, and in particular, white polyester flocking fibers. The flocking fibers provide excellent reinforcement, durability, compressive strength, toughness, abrasion resistance and weatherability. The flocking fibers may be in the present formulations in amounts ranging from 0 wt. % to 5 wt. %, from greater than 0 wt. % to 5 wt. %, preferably from about 0.1 wt. % to 1.0 wt. %, and more preferably from about 0.20 wt. % to 0.70 wt. %, based on a total weight of the RTU formulation.

A crosslinker or crosslinking agent may be included in the present RTU adhesives to strengthen the properties of the resultant adhesives. In one or more embodiments, the crosslinker may include a zinc oxide material having a medium particle size (e.g., about 0.23 m) and exhibiting excellent tack retention. The zinc oxide filler material may be in the present formulations in amounts ranging from 0 wt. % to 6 wt. %, from greater than 0 wt. % to 6 wt. %, preferably from about 0.5 wt. % to 4 wt. %, and more preferably from about 1 wt. % to 3 wt. %, based on a total weight of the RTU formulation.

In one or more embodiments, the present RTU adhesives may further include one or more thickeners. In certain embodiments the present RTU adhesives include a first thickener comprising a clay thickener. For instance, the clay thickener may be a white kaolin sourced from intermediate kaolins, such as those having plate-like crystal structures and high aspect ratios to provide moisture barrier properties. Suitable white kaolin fillers may provide semi-reinforcing properties, enhanced chemical resistance, and provide slow viscosity building properties to allow increased filler loadings without adversely affecting performance and/or handling properties of the resultant RTU adhesive. In one or more embodiments the white kaolin fillers/thickener may be an ultrafine kaolin product having properties including, but not limited to, good semi-reinforcing properties, good color quality, effective TiO2 spacing, and light scattering properties. The first thickener may be present in the instant RTU adhesives in amounts ranging from 0 wt. % to 5 wt. %, from greater than 0 wt. % to 5 wt. %, preferably from about 0.3 wt. % to 1.0 wt. %, and more preferably from about 0.40 wt. % to 0.70 wt. %, based on a total weight of the RTU formulation.

The present RTU adhesives may also include a second thickener comprising a cellulose ether thickener. In one or more embodiments the cellulose ether thickener may be a methylcellulose (MC) derivatives, which are cellulose ethers that, when dissolved in water, offer a variety of functional properties. For instance, the cellulose ether thickener may be a methylhydroxyethylcellulose (MHEC) thickener that provides water retention, workability and cohesiveness to mixtures. Preferably the methylcellulose thickener has properties to control thickening, water demand, improve open time, sag resistance, strength, and importantly, slowing down hydration to allow use in the present RTU adhesives. The second thickener may be in the RTU adhesives in amounts ranging from 0 wt. % to 2 wt. %, from greater than 0 wt. % to 2 wt. %, preferably from about 0.05 wt. % to 0.5 wt. %, and more preferably from about 0.1 wt. % to 0.4 wt. %, based on a total weight of the RTU formulation.

In one or more embodiments the present RTU adhesives may further have a third thickener comprising a silica fume thickener. The silica fume thickener may be a medium surface fumed silica thickener that provides thickening efficiency and dispersibility, shear-thinning, and anti-settling behavior of the instant RTU adhesives. The third thickener may be present in the instant RTU adhesives in amounts ranging from 0 wt. % to 5 wt. %, from greater than 0 wt. % to 5 wt. %, preferably from about 0.05 wt. % to 0.5 wt. %, and more preferably from about 0.1 wt. % to 0.4 wt. %, based on a total weight of the RTU formulation.

The various RTU adhesives of the invention may also include one or more pigments. In certain embodiments the pigment may be a titanium dioxide white powder having good whiteness and dispersibility. The titanium dioxide pigment product preferably has a titanium dioxide content of at least equal to or greater than 93%, with an overall whiteness of about 96%, based on the total product concentration itself. In one or more embodiments the titanium dioxide colorant may be made by advanced chlorination process with special surface treatments. For instance, the titanium dioxide colorant may be a high quality rutile TiO2, coated with dense ZrO2, Al2O3. The pigments/colorants preferably have good whiteness, dispersibility, essentially uniform particle size, weather stability, and high tinting (coloring) power. The pigments may be present in the instant RTU adhesives in amounts ranging from 0 wt. % to 6 wt. %, from greater than 0 wt. % to 6 wt. %, preferably from about 0.5 wt. % to 3.0 wt. %, and more preferably from about 1.4 wt. % to 2.2 wt. %, based on a total weight of the RTU formulation.

The various materials that may be provided within the premixed RTU adhesive formulations, and thereby the resultant adhesives, of the invention are detailed below in Table 1. It should be appreciated that various combinations of the materials described herein may be used in combination with each other to formulate the dispersion-based RTU adhesives of the invention. It should also be appreciated that these formulations render the adhesive material of the invention as well as the resultant adhesive layer after deposition and curing.

Referring to Table 1 below, and the examples of the invention that follow, the premixed RTU dispersion-based formulations of the invention at least include four different binder materials, with at least one binder of such binder materials being a liquid hydraulic cement binder. Also, it is preferred that at least or more of the binders has a high water resistance to provide the resultant RTU adhesives with superior water resistance and physical strength. In accordance with one or more embodiments of the invention, various water-based RTU adhesive formulations of the present invention are described in Table 1 below:

TABLE 1
RTU Adhesive Formulations:

| | | | Preferred | Most Preferred |
|---|---|---|---|---|
| | Property/ | Range | Range | Range |
| Composition | Characteristics | (wt %)* | (wt %)* | (wt %)* |
| Low to medium glass | First Binder | >0-35.0% | 12.0-20.0% | 12.5-18.2% |
| transition temperature | | | | |
| (Tg) acrylic-styrene, | | | | |
| latex binder | | | | |
| High Tg acrylic- | Second Binder | >0-10.0% | 1.0-3.0% | 1.20-2.80% |
| styrene, latex binder | | | | |
| High temperature | Third Binder | >0-20.0% | 2.0-8.0% | 3-6% |
| resistant acrylic- | | | | |
| styrene, latex binder | | | | |
| Liquid hydraulic | Fourth Binder | >0-20.0% | 3.0-12.0% | 4.00-8.00% |
| cement binder | | | | |
| Acrylated compound, | Tackifier | 0-6.0% or >0-6.0% | >0-3.0% | >0.00-2.21% |
| tackifier | | | | |
| In-can Stabilizer | In-Can | 0-2.0% or >0-2.0% | 0.01-0.1% | 0.02-0.05% |
| | Preservative | | | |
| Anti-microbial | Anti-Microbial | 0-2.0% or >0-2.0% | 0.01-0.1% | 0.01-0.04% |
| Adhesion promoter | Adhesion | 0-4.0% or >0-4.0% | 0.1-1.0% | 0.2-0.8% |
| | Promoter | | | |
| Sand | First Filler - | 40.0-85.0% | 65.0-75.0% | 51.0-76.0% |
| | Medium Grade | | | |
| Fine filler | Second Filler - | 0-6.0% or >0-6.0% | 0.3-1.0% | 0.40-0.80% |
| | Fine | | | |
| Perlite-based filler | Third Filler - | 0-4.0% or >0-4.0% | 0.05-1.0% | 0.10-0.60% |
| | Lightweight filler | | | |
| Fiber | First Fiber - | 0-6.0% or >0-6.0% | 0.5-1.5% | 0.9-1.1% |
| | Reinforcement | | | |
| | Fiber | | | |
| Flocking Fiber | Second Fiber - | 0-5.0% or >0-5.0% | 0.1-1.0% | 0.20-0.70% |
| | Polyester Flock | | | |
| Zinc Oxide | Crosslinker | 0-6.0% or >0-6.0% | 0.5-4.0% | 1.0-3.0% |
| Pigment | Colorant | 0-6.0% or >0-6.0% | 0.5-3.0% | 1.40-2.20% |
| Clay thickener | First Thickener | 0-5.0% or >0-5.0% | 0.3-1.0% | 0.40-0.7% |
| Cellulose ether | Second | 0-2.0% or >0-2.0% | 0.05-0.5% | 0.10-0.40% |
| thickener | Thickener | | | |
| Silica fume thickener | Third Thickener | 0-5.0% or >0-5.0% | 0.05-0.5% | 0.10-0.40% |
| TOTAL | | 100% | 100% | 100% |
| FORMULATION | | | | |

*Range weight % based on total weight of adhesive formulation

It has been found that the instant water-based RTU adhesive formulations of the invention are low in VOCs, do not have any potential health risks to the user/applicator, and potentially no skin sensitization. It has further been found that the RTU adhesive formulations provide resultant adhesive products with superior water resistance and superior physical strength, as well as provide improved curing of the resultant adhesive when applied between two non-porous surfaces, in high humidity environments, and/or environments/settings having low temperatures, as compared to known RTU adhesives.

While not meant to be limiting, for ease of understanding the invention, an exemplary RTU dispersion-based adhesive formulation of the invention is described below in Table 2.

TABLE 2
In accordance with the invention, while not meant to be limiting, an
exemplary RTU adhesive formulation of the invention that meets performance
requirements of a modified dry-set cement mortar is as follows:

| Example 1 (Sample RTU Adhesive) | | |
|---|---|---|
| Composition | Property/Characteristics | Wt. %* |
| Low to medium glass transition | First Binder | 15.19% |
| temperature (Tg) acrylic- | | |
| styrene, latex binder | | |
| High Tg acrylic- | Second Binder | 4.60% |
| styrene, latex binder | | |
| High temperature resistant acrylic- | Third Binder | 4.60% |
| styrene, latex binder | | |
| Liquid hydraulic cement binder | Fourth Binder | 6.43% |
| Acrylated compound, tackifier | Tackifier | 1.84% |
| In-can Stabilizer | In-Can Preservative | 0.03% |
| Anti-microbial | Anti-Microbial | 0.02% |
| Silane adhesion promoter | Adhesion Promoter | 0.28% |
| Sand (medium grade) | First Filler - | 63.89% |
| | Medium Grade | |
| Fine filler, CaCO3 | Second Filler - Fine | 0.55% |
| Perlite-based filler | Third Filler - Lightweight | 0.21% |
| | filler | |
| Pigment - TiO₂ | Colorant | 1.84% |
| Clay thickener | First Thickener | 0.55% |
| Cellulose ether thickener | Second Thickener | 0.22% |
| Silica fume thickener | Third Thickener | 0.27% |
| Flocking Fiber | Fiber | 0.40% |
| Zinc Oxide | Crosslinker | 1.84% |
| TOTAL FORMULATION | | 100% |

*Range weight % based on total weight of adhesive formulation

### Activator:

In accordance with embodiments of the invention, once the various water-based RTU adhesives of the invention are formulated, they may be used to adhere tiles and/or stone to a substrate surface. In doing so the water-based RTU adhesive(s) of the invention is applied to a surface area, and then a sufficient amount of an alkaline curing agent comprising an alkaline solution is sprayed over the top exposed surface of the deposited/applied/layed RTU adhesive. The alkaline solution is applied in an amount until the exposed surface area of the deposited RTU adhesive is sufficiently wetted. The alkaline solution acts as an activator by interacting with the liquid hydraulic cement binder residing in the RTU adhesive and inducing a hydraulic reaction therebetween. This hydraulic reaction may extend partially into a depth of the deposited RTU adhesive, causing the adhesive to cure faster—as compared to known RTU adhesives that do not have a liquid hydraulic cement binder therein.

Various alkaline curing agents are suitable for use in the invention. Each alkaline solution includes water as the diluent and one or more alkaline compositions. These alkaline compositions may include, but are not limited to, lithium hydroxide (LiOH), lithium silicate, LiSO₄, NaOH, KOH, sodium carbonate (Na₂CO₃), and various combinations thereof. In those embodiments of the invention where the liquid hydraulic cement binder is an aqueous alumina (calcium aluminate) cement suspension, it is preferred that the alkaline curing agent (hydraulic reaction inducer) is an alkaline liquid containing no calcium salt. While not meant to be limiting, suitable alkaline curing agents or activator solutions may include the following below Examples 1-8.

### Example 1 Activator Solution

| RAW Material | Description | Range wt. % |
|---|---|---|
| LiSO₄ | Hydraulic Binder Accelerator | 0.1-10.0% |
| NaOH | Alkaline | 0.1-10.0% |
| Water | Diluent | 99.8-80.0% |

### Example 2 Activator Solution

| RAW Material | Description | % Range, wt |
|---|---|---|
| Lithium Hydroxide (LiOH) | Alkaline/Accelerator | 0.1-10% |
| Water | Diluent | 99.9-90.0% |

### Example 3 Activator Solution

| RAW Material | Description | Range wt. % |
|---|---|---|
| Lithium Silicate | Alkaline/Accelerator | 0.1-60% |
| Water | Diluent | 99.9-40.0% |

### Example 4 Activator Solution

| RAW Material | Description | Range wt. % |
|---|---|---|
| LiSO₄ | Hydraulic Binder Accelerator | 0.1-10.0% |
| KOH | Alkaline | 0.1-10.0% |
| Water | Diluent | 99.8-80.0% |

### Example 5 Activator Solution

| RAW Material | Description | Range wt. % |
|---|---|---|
| LiSO₄ | Hydraulic Binder | 0.1-10.0% |
| | Accelerator | |
| Sodium | Alkaline | 0.1-10.0% |
| Carbonate (Na₂CO₃) | | |
| Water | Diluent | 99.8-80.0% |

### Example 6 Activator Solution

| RAW Material | Description | Range wt. % |
|---|---|---|
| Sodium Carbonate (Na₂CO₃) | Alkaline | 0.1-20.0% |
| Water | Diluent | 99.9-80.0% |

### Example 7 Activator Solution

| RAW Material | Description | Range wt. % |
|---|---|---|
| LiSO₄ | Hydraulic Binder Accelerator | 5.00-10.00% |
| NaOH | Alkaline | 5.00-10.00% |
| Water | Diluent | 80.00-90.00% |

### Example 8 Activator Solution

| RAW Material | Description | Range wt. % |
|---|---|---|
| LiOH | Hydraulic Binder Accelerator | 5.00-10.00% |
| NaOH | Alkaline | 5.00-10.00% |
| Water | Diluent | 80.00-90.00% |

In demonstrating the improved and faster curing of the present water-based RTU adhesives, tests were conducted to compare known RTU adhesives not having a hydraulic cement binder to those of the present invention, i.e., water-based RTU adhesives of the invention having a liquid hydraulic cement binder.

In each of the below examples, a known RTU adhesive and an RTU adhesive of the invention were applied over a liquid applied waterproofing membrane substrate residing on a backerboard, followed by providing a 24″×24″ porcelain tile thereover. The RTU adhesive of the invention was tested both without spraying an alkaline activator solution over the deposited RTU adhesive before laying the tile thereover. The RTU adhesive of the invention was also tested with an applied layer of alkaline activator solution, whereby after the RTU adhesive is applied to the membrane substrate, the alkaline activator solution is deposited over the exposed surface area (preferably sprayed over) in an amount sufficient to wet (preferably visibly wet) the exposed RTU adhesive to induce a hydraulic reaction. The porcelain tile is then deposited over the hydraulically activated RTU adhesive. A cementitious grout was applied between the tiles after 24 hours, and then the examples were allowed to cure. The results are shown in Table 3.

TABLE 3
Comparative tests as described above. Shore D Control Fully cured: ~52.

| | ° F./% | | | |
|---|---|---|---|---|
| | Relative | | | |
| | Humidity | | | |
| Formula | (RH) | 7-day Cure | 14-day Cure | 28-day Cure |
| PRIOR ART | 72° F. | Uncured | Cured with 6 inch | Cured |
| RTU Adhesive | 48% RH | | of outside tiles. | Shore D Hardness: |
| Formula with NO | | | Shore D: 16; | 37 |
| Liquid Hydraulic | | | Drier, but still | |
| Cement | | | gummy 6 inches | |
| | | | into 2 × 2 tile | |
| INVENTION | 72° F. | Uncured | Uncured: <6 in | Full Cure |
| RTU Adhesive | 48% RH | | depth | Shore D Hardness: |
| Formula with Liquid | | | | 48 |
| Hydraulic Cement, | | | | |
| No Activator | | | | |
| INVENTION | 72° F. | Full Cure | | |
| RTU Adhesive | 48% RH | Shore D | | |
| Formula with Liquid | | Hardness: 46 | | |
| Hydraulic Cement, | | | | |
| With Activator | | | | |

The above comparative tests demonstrate that the present water-based RTU adhesives having a liquid hydraulic cement binder are suitable for use in adhering “tiles” to an underlying substrate. If the present RTU adhesives are left untreated, that is, not treated with an alkaline activator solution, such adhesive takes a long time to cure in harsh conditions having low temperatures and high humidity. However, if the present RTU adhesives are used in combination with and treated by one of the various alkaline activator solutions of the invention, a hydraulic reaction is generated with such RTU adhesive to speed up and enhance the cure time thereof in environments having lower temperatures and/or higher relative humidity. It is contemplated in the invention that the present water-based RTU adhesives having a liquid hydraulic cement binder and the alkaline activator solution may be combined together in kit form as two separate units sold together.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A tile adhesive in a ready-to-use formulation comprising:
a first binder material comprising a low-medium Tg acrylic-styrene latex binder;
a second binder material comprising a high Tg acrylic-styrene latex binder;
a third binder material comprising a high temperature resistant acrylic-styrene latex binder;
a fourth binder material comprising a liquid hydraulic cement binder; and
one or more additional ingredients,
wherein the adhesive formulation is a one-part formulation requiring no mixing prior to use.

2. The adhesive of claim 1 wherein the fourth binder material comprises an aqueous calcium aluminate cement suspension.

3. The adhesive of claim 1 wherein,
the first binder material is present in an amount ranging from greater than 0 wt. % to 35 wt. %;
the second binder material is present in an amount ranging from greater than 0 wt. % to 10 wt. %;
the third binder material is present in an amount ranging from greater than 0 wt. % to 20 wt. %;
the fourth binder material is present in an amount ranging from greater than 0 wt. % to 20 wt. %,
wherein weight % is based on total weight of the adhesive formulation.

4. The adhesive of claim 1 wherein,
the first binder material is present in an amount ranging from 12 wt. % to 20 wt. %;
the second binder material is present in an amount ranging from 1 wt. % to 3 wt. %;
the third binder material is present in an amount ranging from 2 wt. % to 8 wt. %;
the fourth binder material comprises an aqueous calcium aluminate cement present in an amount ranging from 3 wt. % to 12 wt. %,
wherein weight % is based on total weight of the adhesive formulation.

5. The adhesive of claim 1 wherein the one or more additional ingredients may be selected from the group consisting of a tackifier, an in-can stabilizer, an anti-microbial, an adhesion promoter, sand, pigment, one or more thickeners, one or more filler materials, and combinations thereof.

6. The adhesive of claim 1 wherein the one or more additional ingredients include:
a tackifier;
an in-can stabilizer;
an anti-microbial;
an adhesion promoter;
sand;
pigment;
one or more fiber materials;
one or more thickeners; and
one or more additional filler materials,
wherein the adhesive formulation is a one-part formulation requiring no mixing prior to use.

7. The adhesive of claim 6 wherein the one or more additional ingredients include:
the tackifier comprising an acrylated compound present in an amount ranging from greater than 0 wt. % to 3 wt. %;
the in-can stabilizer is present in an amount ranging from 0.01 wt. % to 0.1 wt. %;
the anti-microbial is present in an amount ranging from 0.01 wt. % to 0.1 wt. %;
the adhesion promoter is present in an amount ranging from 0.1 wt. % to 1 wt. %; and
the sand is present in an amount ranging from 65 wt. % to 75 wt. %,
wherein the adhesive formulation is a one-part formulation requiring no mixing prior to use.

8. The adhesive of claim 7 wherein the one or more thickeners comprise:
a first thickener comprising a clay thickener present in an amount ranging from 0.3 wt. % to 1 wt. %;
a second thickener comprising a cellulose thickener present in an amount ranging from 0.05 wt. % to 0.5 wt. %; and
a third thickener comprising a silica fume thickener present in an amount ranging from 0.05 wt. % to 0.5 wt. %;
wherein weight % is based on total weight of the adhesive formulation.

9. The adhesive of claim 7 wherein the one or more fiber materials comprise:
a first fiber comprising a reinforcement fiber present in an amount ranging from 0.5 wt. % to 1.5 wt. %; and
a second fiber comprising flocking fibers present in an amount ranging from 0.1 wt. % to 1.0 wt. %.

10. The adhesive of claim 7 further including:
a fine filler material present in an amount ranging from 0.3 wt. % to 1.0 wt. %;
a lightweight filler material present in an amount ranging from 0.05 wt. % to 1.0 wt. %;
a crosslinker material present in an amount ranging from 0.5 wt. % to 4.0 wt. %; and
a colorant material present in an amount ranging from 0.5 wt. % to 3.0 wt. %.

11. A method of bonding tile to a substrate comprising:
providing a ready-to-use (RTU) tile adhesive comprising:
a first binder material comprising a low-medium Tg acrylic-styrene latex binder;
a second binder material comprising a high Tg acrylic-styrene latex binder;
a third binder material comprising a high temperature resistant acrylic-styrene latex binder;
a fourth binder material comprising a liquid hydraulic cement binder; and
one or more additional ingredients, wherein the adhesive formulation is a one-part formulation requiring no mixing prior to use;
applying the RTU tile adhesive to a substrate;
providing an alkaline activator solution comprising one or more alkaline compositions in an aqueous diluent;
depositing the alkaline activator solution to an exposed surface of the RTU tile adhesive to induce a hydraulic reaction between the liquid hydraulic cement binder and the alkaline activator solution;
laying the tile over the hydraulically induced RTU tile adhesive to attach the tile to the RTU tile adhesive; and
curing the hydraulically induced RTU tile adhesive to bond the tile to the RTU tile adhesive.

12. The method of claim 11 wherein the fourth binder material comprises an aqueous calcium aluminate cement suspension.

13. The method of claim 11 wherein the one or more alkaline compositions are selected from the group consisting of lithium hydroxide, lithium silicate, LiSO₄, NaOH, KOH, sodium carbonate, and combinations thereof.

14. The method of claim 11 wherein the aqueous diluent comprises water, the alkaline activator solution comprising the one or more alkaline compositions present in an amount ranging from 0.1 wt. % to 40 wt. %, and the water present in an amount ranging from 99.9 wt. % to 60 wt. %, based on a total weight of the alkaline activator solution.

15. The method of claim 13 wherein the one or more alkaline compositions and the aqueous diluent comprise a combination of LiSO₄ and, NaOH or KOH, in water.

16. The method of claim 13 wherein the one or more alkaline compositions and the aqueous diluent comprise a combination of lithium hydroxide in water.

17. The method of claim 13 wherein the one or more alkaline compositions and the aqueous diluent comprise a combination of lithium silicate in water.

18. The method of claim 13 wherein the one or more alkaline compositions and the aqueous diluent comprise a combination of Na₂CO₃ in water.

19. The method of claim 13 wherein the one or more alkaline compositions and the aqueous diluent comprise a combination of NaOH and, LiSO₄ or LiOH, in water.

20. A tile bonding system for adhering tile to a substrate comprising:
a ready-to-use (RTU) tile adhesive comprising;
a first binder material comprising a low-medium Tg acrylic-styrene latex binder present in an amount ranging from 12 wt. % to 20 wt. %;
a second binder material comprising a high Tg acrylic-styrene latex binder present in an amount ranging from 1 wt. % to 3 wt. %;
a third binder material comprising a high temperature resistant acrylic-styrene latex binder present in an amount ranging from 2 wt. % to 8 wt. %;
a fourth binder material comprising a liquid hydraulic cement binder present in an amount ranging from 3 wt. % to 12 wt. %;
one or more additional ingredients, wherein the adhesive formulation is a one-part formulation requiring no mixing prior to use; and
an alkaline activator solution comprising one or more alkaline compositions in an aqueous diluent,
wherein the RTU tile adhesive and the alkaline activator solution are separate distinct components, with the RTU tile adhesive being deposited on the substrate surface first followed by depositing the alkaline activator solution over the deposited RTU tile adhesive to induce a reaction therewith.
